(19) United States
(12) Patent Application Publication
(10) Pub. No.: US 2013/0243416 A1
(43) Pub. Date: Sep. 19, 2013

(54) OPTICAL NETWORK ARCHITECTURE FOR TRANSPORTING WDM TRAFFIC

(71) Applicants: Stefan Dahlfort, Santa Clara, CA (US); Fabio Cavaliere, Vecchiano (Pisa) (IT)

(72) Inventors: Stefan Dahlfort, Santa Clara, CA (US); Fabio Cavaliere, Vecchiano (Pisa) (IT)

(21) Appl. No.: 13/420,416

(22) Filed: Mar. 14, 2012

(51) Int. Cl. H04J 14/02; H04B 10/08

(52) U.S. Cl. 398/5; 398/49

(57) ABSTRACT

A peer network node, along with other peer network nodes, forms a higher-tiered optical network that transports wavelength division multiplexed traffic for multiple lower-tiered optical networks. The node comprises a plurality of dedicated bidirectional optical ports, including two or more lower-tiered ports and one or more peer ports. The node also comprises one or more hub-side bidirectional optical ports, and a switching circuit. The switching circuit is configured to distribute traffic received at the one or more hub-side ports to respective dedicated ports, for dedicated transport to one or more of the lower-tiered networks and peer network nodes. The switching circuit is also configured to direct any traffic received at the dedicated ports to the one or more hub-side ports for transport to a hub node, even if that traffic is actually destined for one of the lower-tiered networks to which a lower-tiered port is connected.

### TECHNICAL FIELD

The present invention generally relates to a tiered optical network architecture for transporting wavelength division multiplexed (WDM) traffic, and particularly relates to a higher-tiered optical network composed of peer network nodes that have reduced complexity.

### BACKGROUND

Increasing the flexibility with which an optical transport network can route wavelength division multiplexed (WDM) traffic has traditionally increased the efficiency of the network. Reconfigurable optical add/drop multiplexers (ROADMs) have greatly contributed to this increased routing flexibility by enabling traffic at the wavelength granularity to be selectively added or dropped at any node in the network. However, ROADMs employ fairly complex and expensive components to provide this flexible routing capability, meaning that ROAMDs prove cost-prohibitive in some contexts.

One such context relates to a network that efficiently transports the traffic of multiple services in a converged fashion. Rather than employing multiple different networks in parallel for transporting these different services (e.g., mobile, business, and residential services), a converged network transports those services together using the same network. A transport network that optically converges different services by transporting those services on different wavelengths would be advantageous, for a variety of reasons, but has heretofore been precluded by the high cost of the necessary hardware components (e.g., ROADMs).

Consequently, known transport networks converge different services using packet aggregation instead. While packet aggregation currently requires less hardware expense for converged transport, that expense will not scale equally with the significant traffic increases expected in the near future. Moreover, while packet aggregation suffices in many respects for realizing convergence, it proves inefficient in implementation. Indeed, converging multiple services at the packet level involves significant complexity in order to accommodate the different packet requirements associated with the different services.

### SUMMARY

Embodiments herein advantageously reduce the complexity and accompanying cost of nodes in an optical network that transports WDM traffic, as compared to known networks. With reduced complexity and cost, the embodiments prove particularly useful for optically converging the traffic of multiple services. In fact, some embodiments exploit the increased traffic resulting from such convergence in order to eliminate or at least mitigate the complexity that known networks incur for flexibility in traffic routing.

More particularly, embodiments herein include a peer network node that is configured, in conjunction with other peer network nodes, to form a higher-tiered optical network that transports WDM traffic for multiple lower-tiered optical networks. These higher and lower tiered networks may respectively be a metro network and an access network, a regional network and a metro network, etc. Regardless, the peer network node comprises a plurality of dedicated bidirectional optical ports. These ports include two or more so-called lower-tiered ports and one or more so-called peer ports. Each lower-tiered port is dedicated for transporting WDM traffic to and from an individual lower-tiered network, while each peer port is dedicated for transporting WDM traffic to and from an individual peer network node. The bidirectional nature of each such ports advantageously enables WDM traffic to be transported between the peer network node and any given lower-tiered network or peer network node via a single optical fiber.

The peer network node further includes one or more so-called hub-side bidirectional optical ports. Each hub-side port is configured to transport WDM traffic to and from a hub node in the higher-tiered network. Further, at least one of the ports is a common port configured to transport WDM traffic aggregated across multiple lower-tiered ports. Similarly to the lower-tiered ports, the bidirectional nature of each hub-side port advantageously enables WDM traffic to be transported between the hub-side port and the hub node via a single optical fiber.

The peer network node finally includes a switching circuit. The switching circuit is configured to distribute WDM traffic received at the one or more hub-side ports to respective dedicated ports for dedicated transport to one or more of the lower-tiered networks and peer network nodes. Notably, the switching circuit is also configured to direct any WDM traffic received at the dedicated ports to the one or more hub-side ports for transport to the hub node, even if that traffic is actually destined for one of the lower-tiered networks to which a lower-tiered port is connected. This reduced routing flexibility, in conjunction with the bidirectional nature of the ports, advantageously reduces the complexity and cost of the peer network node, while at the same time satisfying the routing requirements for a wider range of applications.

In at least some embodiments, for example, the peer network node includes a single wavelength selective switch (WSS), which significantly reduces the complexity and cost of the node as compared to known approaches that employ a ROADM with at least two WSSs. In this and other embodiments, the node may also include a bypass path that bypasses traffic received at a peer port around any WSSs in the peer network node to a hub-side port, for transport to the hub node. Alternatively, the traffic received at the peer port may be input into a WSS, for aggregated transport to the hub with other traffic, e.g., lower-tiered network traffic.

One or more embodiments herein also provide for enhanced resiliency to faults in the network. In some embodiments, for instance, at least two different dedicated ports of the peer network node receive the same traffic. The switching circuit is configured to direct that traffic to a hub-side port by dynamically selecting from which dedicated port to acquire the traffic. This dynamic selection is based on a control signal associated with any faults in the higher or lower-tiered networks affecting those dedicated ports.

In other embodiments, the node alternatively employs redundancy for its connection to the hub node, in order to protect against faults in those connections or in any intermediate peer nodes. In this case, the node includes a redundant hub-side bidirectional optical port that is configured to transport the same traffic as another hub-side port, but to transport that traffic to and from a different, redundant hub node.

In still other embodiments, the node employs both redundancy for a lower-tiered network or a peer network node, and redundancy for its connection to the hub node. Such embodiments may utilize an additional WSS for realizing this enhanced resiliency. Some embodiments may further utilize an optical switch for protecting against a single simultaneous failure in both a connection to a lower-tiered network and a connection to a hub node.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a generic tiered architecture for optical transport networks configured to transport wavelength division multiplexed (WDM) traffic, according to one or more embodiments.

FIG. 2 is a block diagram of a peer network node configured to transport WDM traffic according to one or more embodiments.

FIG. 3 is a block diagram of a peer network node configured with a bypass path for bypassing WDM traffic around any wavelength selective switches (WSSs) in the node, according to one or more embodiments.

FIG. 4 is a block diagram of a peer network node configured with a single WSS and a bypass path according to some embodiments.

FIG. 5 is a block diagram of a peer network node configured with a single WSS, but no bypass path, according to other embodiments.

FIG. 6 is a block diagram of a peer network node configured with one or more redundant hub-side bidirectional optical ports according to one or more embodiments.

FIG. 7 is a block diagram of a peer network node configured with a splitter/combiner circuit for also distributing WDM traffic to one or more redundant hub-side ports, according to some embodiments.

FIG. 8 is a block diagram of a peer network node configured with at least two WSSs for WSS redundancy, according to one or more embodiments.

FIG. 9 is a block diagram of a peer network node configured with an optical switch for protecting against single simultaneous failure of both a connection to a lower-tiered network and a connection to a hub node, according to some embodiments.

FIG. 10 is a block diagram of the redundant interconnection of multiple peer network nodes according to one or more embodiments.

FIG. 11 is a block diagram of a hub node configured with dedicated ports and WSSs that are each dedicated to transporting traffic for an individual peer network node, according to one or more embodiments.

FIG. 12 is a logic flow diagram of a method implemented by a peer network node, according to one or more embodiments.

FIG. 13 is a logic flow diagram of a method implemented by a hub node, according to some embodiments.

### DETAILED DESCRIPTION

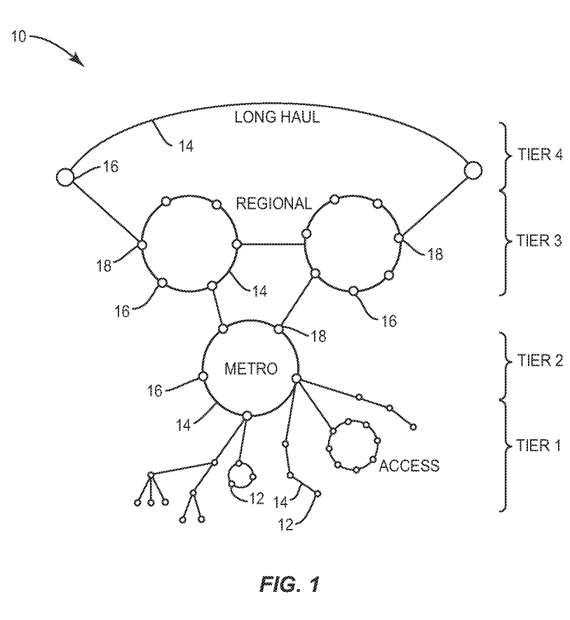

FIG. 1 illustrates a generic tiered architecture 10 for optical transport networks configured to transport wavelength division multiplexed (WDM) traffic. The lowest tier shown, tier 1, includes a plurality of access networks that are each formed from a plurality of access nodes 12 interconnected via optical fiber 14 in a ring structure, a tree structure, a bus structure, a mesh structure, or any combination thereof. In general, each access network aggregates uplink WDM traffic from the network and places that aggregated traffic onto a higher-tiered network; namely, a metro network at tier 2. The metro network is formed from a plurality of interconnected peer network nodes 16, also referred to as central offices (COs), and transports WDM traffic for the plurality of access networks. In this regard, each peer network node 16 aggregates WDM traffic from one or more access networks to which it is connected and transports that aggregated traffic to a hub node 18 in the metro network.

The hub node 18 connects uplink WDM traffic from one or more network nodes 16 to a higher-tiered network called the regional network. More specifically, the hub node 18 routes uplink WDM traffic to an appropriate one of multiple edge nodes (not shown), e.g., a business services edge router, a residential services or mobile services broadband network gateway (BNG), a broadband remote access server (BRAS), etc. The edge node then performs subscriber management and routes the uplink traffic (typically at the packet level) towards an appropriate destination, such as to content servicers, back towards the access networks, to the Internet, etc. Such edge node routing may entail sending the uplink traffic to the regional network, which operates back at the optical layer. Thus, although omitted from FIG. 1 for simplicity of illustration, the hub node 18 connects to multiple edge nodes and the edges nodes in turn connect to the regional transport network.

The regional network is also formed from a plurality of interconnected peer network nodes 16, which hub WDM traffic to a hub node 18 in the regional network much the same as in the metro network. Traffic from the regional network is then placed onto a long haul network at tier 4, for inter-regional transport. Downlink WDM traffic propagates through the networks in an analogous, but opposite, manner.

Known implementations of this tiered architecture 10 configure each peer network node 16 with significant routing flexibility. Each peer network node 16, for example, includes a reconfigurable optical add/drop multiplexers (ROADM) that enables any WDM traffic to be selectively added or dropped from the node 16. Equipped with such hardware, a peer network node 16 can immediately drop any uplink traffic that is received from another peer network node 16 if that traffic is destined for a connected lower-tiered network. However, because each ROADM requires at least two wavelength selective switches (WSSs) just to provide this flexible routing capability and may require additional WSSs to provide full flexibility in adding or dropping wavelengths, known implementations prove cost-prohibitive and/or operationally limited in some contexts.

Embodiments herein advantageously reduce the complexity and accompanying cost of peer network nodes 16. With reduced complexity and cost, the embodiments prove useful in a wider range of applications, such as optically converging the traffic of multiple services. In fact, some embodiments exploit the increased traffic resulting from such convergence in order to eliminate or at least mitigate the complexity that known networks incur for flexibility in traffic routing.

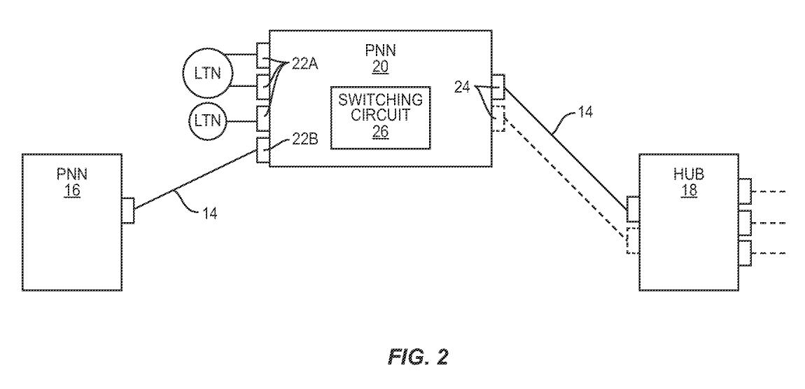

FIG. 2 depicts one embodiment of a peer network node (PNN) 20 in this regard. In conjunction with other peer network nodes 16, the peer network node 20 forms a higher-tiered optical network that transports WDM traffic for multiple lower-tiered optical networks. These higher and lower tiered networks may respectively be a metro network and an access network, a regional network and a metro network, etc. Regardless, the peer network node 20 comprises a plurality of dedicated bidirectional optical ports 22. These ports 22 include two or more so-called lower-tiered ports 22A and one or more so-called peer ports 22B. Each lower-tiered port 22A is dedicated for transporting WDM traffic to and from an individual lower-tiered network (LTN), while each peer port 22B is dedicated for transporting WDM traffic to and from an individual peer network node 16. The bidirectional nature of each such ports 22 advantageously enables WDM traffic to be transported between the peer network node 20 and any given lower-tiered network or peer network node 16 via a single optical fiber 14.

The peer network node 20 further includes one or more so-called hub-side bidirectional optical ports 24. Each hub-side port 24 is configured to transport WDM traffic to and from a hub node 18 in the higher-tiered network. Further, at least one of the ports 24 is a common port configured to transport WDM traffic aggregated across multiple lower-tiered ports 22A.

Although as shown the hub-side ports of peer network node 20 transport traffic directly to and from a hub node 18, rather than indirectly via one or more other peer network nodes 16, this need not be the case. Indeed, the ports 24 are hub-side merely in the sense that traffic input into or output from such ports 24 at some point in time originates from or is destined for a hub node 18. Similarly to the lower-tiered ports 22, the bidirectional nature of each hub-side port 24 advantageously enables WDM traffic to be transported between the hub-side port 24 and the hub node 18 via a single optical fiber 14.

The peer network node 20 finally includes a switching circuit 26. The switching circuit 26 is configured to distribute WDM traffic received at the one or more hub-side ports 24 to respective dedicated ports 22A, 22B for dedicated transport to one or more of the lower-tiered networks and peer network nodes 16. Notably, the switching circuit 26 is also configured to direct any WDM traffic received at the dedicated ports 22A, 22B to the one or more hub-side ports 24 for transport to the hub node 18, even if that traffic is actually destined for one of the lower-tiered networks to which a lower-tiered port 22A is connected.

By unconditionally transporting traffic to the hub node 18 in this way, the switching circuit 26 has reduced flexibility in routing WDM traffic. Indeed, traffic received at a dedicated port 22 that is destined for a lower-tiered port 22A must first be routed to the hub node 18, and then back to the peer network node 20 before finally being routed to that lower-tiered port 22A. But as demonstrated in greater detail below, this reduced routing flexibility in conjunction with the bidirectional nature of the ports 22, 24, advantageously reduces the complexity and cost of the peer network node 20, while at the same time satisfying the routing requirements for a wider range of applications.

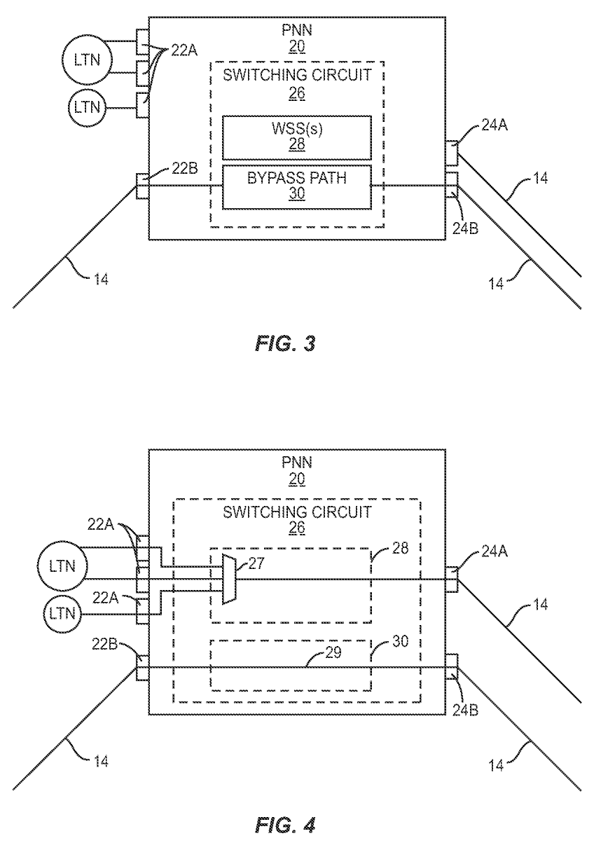

Consider, for example, the embodiment illustrated in FIG. 3. As shown in FIG. 3, the peer network node 20 includes two hub-side ports 24A and 24B. Hub-side port 24A is the common port that is configured to transport WDM traffic aggregated across multiple lower-tiered ports 22A. Hub-side port 24A may, for instance, transport traffic aggregated by one or more wavelength selective switches (WSSs) 28 comprised in the switching circuit 26. A WSS as used herein is configured to selectively switch or otherwise route each wavelength received at its common port to any one of its dedicated ports, independently of how other wavelengths are routed, and to aggregate wavelengths received at its dedicated ports for output from its common port. By contrast, hub-side port 24B is dedicated for transporting traffic received at peer port 22B to the hub node 18 and for transporting traffic received from the hub node 18 to peer port 22B.

In this regard, the switching circuit 26 advantageously includes a bypass path 30. The bypass path 30 is a circuit configured to bypass traffic received at hub-side port 24B around the one or more WSSs 28 to peer port 22B, for transport to an associated peer network node 16. Likewise, the bypass path 30 bypasses traffic received at peer port 22B around the one or more WSSs 28 to hub-side port 24B, for transport to the hub node 18. The bypass path 30 transports traffic to the hub node 18 in this way, even if that traffic is actually destined for a lower-tiered network to which a lower-tiered port 22A is connected. In doing so, the bypass path 30 effectively eliminates any flexibility with which the peer network node 20 would otherwise be able to route the traffic received at ports 22B, 24B, to correspondingly reduce the complexity and cost of the node 20.

Yet even with this reduced complexity and cost, the node 20 still proves useful in a wider range of applications. In one embodiment, for example, the node 20 is configured to transport the WDM traffic of multiple services (e.g., mobile, business, and residential services) in a converged fashion. This convergence may substantially increase traffic utilization of the optical fiber 14 connecting the node 20 to a peer network node 16 at the peer port 22B, perhaps to near capacity. If so, little if any additional traffic should be added to that fiber 14 from the lower-tiered networks to which the node 20 is connected. The node 20 thereby exploits the filling of the fiber 14 to substantially full capacity as an opportunity to reduce the complexity and cost of the node, by bypassing the fiber 14 and the traffic it carries around the WSSs 28 that would otherwise add additional traffic to the fiber 14.

Of course, if any of that bypassed traffic was actually destined for one of the lower-tiered networks, the traffic may be routed back from the hub node 18 to the peer network node's hub-side port 24A. From port 24A, the traffic is then distributed to the appropriate lower-tiered network. Because in many applications this additional round-trip transport is needed only very rarely, the complexity and cost reductions obtained from the bypass path 30 still prove advantageous on balance.

Indeed, as shown in FIG. 4, the complexity and cost reductions may be substantial, with the node 20 in at least some embodiments employing only a single WSS 27 (rather than multiple WSSs as in known approaches that employ a ROADM). In this case, the lower-tiered ports 22A correspond to the dedicated ports of the WSS 27, and hub-side port 24A corresponds to the common port of the WSS 27. As used herein, a port corresponds to another port if the two ports transport the same WDM traffic. The bypass path 30 may simply comprise a pass-through circuit 29 that includes one or more single-input, single-output fiber optic couplers or interconnects for connecting the fiber 14 at port 22B to the fiber 14 at port 24B.

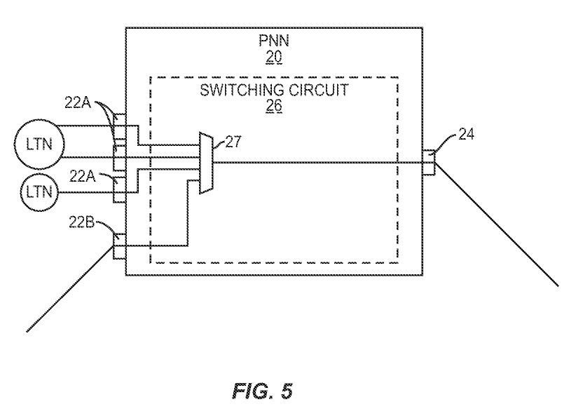

Other embodiments herein, by contrast, contemplate that the reduction in complexity and cost results exclusively from the inclusion of a single WSS 27 in the node 20, rather than also from the inclusion of a bypass path 30. FIG. 5 illustrates one such embodiment, which proves particularly useful in cases where the fiber 14 at peer port 22B has not been substantially filled to capacity. As shown in FIG. 5, the peer network node 20 comprises a single WSS 27. Rather than just the lower-tiered ports 22A corresponding to the dedicated ports of the WSS 27, as in FIGS. 3 and 4, both the lower-tiered ports 22A and the peer port 22B correspond to the WSS's dedicated ports. The WSS 27 aggregates WDM traffic from these ports 22A, 22B and outputs that traffic at its common port, which corresponds to a single hub-side port 24 of the node 20. Conversely, the WSS 27 distributes WDM traffic received at the hub-side port 24 to respective dedicated ports 22A, 22B.

Regardless of the particular manner in which the complexity and cost of the node 20 are reduced, that reduction permits the node 20 to realize substantially the same meaningful functionality, with less expense. The reduction may additionally or alternatively permit the node 20 to realize new functionality, such as enhanced resiliency to faults in the network.

In one embodiment, for example, the node 20 employs redundancy for a lower-tiered network or a peer network node 16 to which it is connected, in order to protect against faults in the connection to that network or node 16. In this case, at least two different dedicated ports 22 of the node 20 receive the same traffic. The switching circuit 26 is configured to direct that traffic to a hub-side port 24 by dynamically selecting from which dedicated port 22 to acquire the traffic. This dynamic selection is based on a control signal associated with any faults in the higher or lower-tiered networks affecting those dedicated ports 22.

As one example of this, FIG. 5 shows two dedicated ports 22 of the node 20 connected to the same lower-tiered network 32. Where for instance the lower-tiered network 32 is a ring network, the dedicated ports 22 may connect to different arms/directions of the ring. Regardless, the two ports 22 receive the same traffic in a redundant manner. However, the WSS 27 is configured to dynamically select the traffic from only one of those ports 22, for aggregating and sending to the hub node 18. The WSS 27 dynamically configures this selection responsive to a control signal indicating a fault in one of the connections to the lower-tiered network 32. The WSS 27 may receive this control signal from the hub node 18, as described in greater detail below.

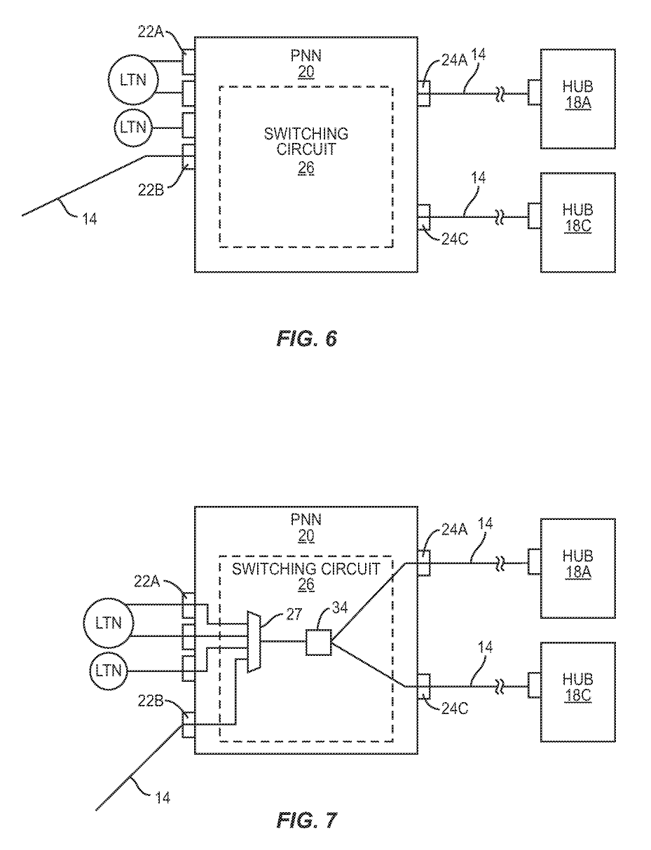

In other embodiments, the node 20 alternatively employs redundancy for its connection to the hub node 18, in order to protect against faults in those connections or in any intermediate peer nodes 16. FIG. 6 illustrates one such embodiment. As shown in FIG. 6, the node 20 includes a redundant hub-side bidirectional optical port 24C. This redundant port 24C is configured to transport the same traffic as the previously-mentioned hub-side port 24A. However, the redundant port 24C does not transport the traffic to and from the same hub node 18 as hub-side port 24A. Instead, hub-side port 24A transports the traffic to and from hub node 18A, and redundant hub-side port 24C transports the traffic to and from a redundant hub node 18C. The switching circuit 26 is correspondingly configured to direct any traffic received at the dedicated ports 22 also to the one or more redundant hub-side ports 24C for transport to the redundant hub node 18C. This way, if the connection to either of the hub nodes 18A, 18C fails, e.g., because of a fiber outage, an intermediate peer network node failure, or a hub node failure, traffic is still transported via the connection to the other hub node 18C, 18A.

FIG. 7 depicts one exemplary implementation of these embodiments in the context of a node 20 that includes a single WSS 27, but no bypass path 30. As shown in FIG. 7, the switching circuit 26 further includes a splitter/combiner circuit 34. The splitter/combiner circuit 34 is configured to distribute the traffic output from the common port of the WSS 27 to both hub-side port 24A and redundant hub-side port 24C, for redundant transport of the same traffic to hub node 18A and redundant hub node 18C. Conversely, the splitter/combiner circuit 34 is configured to combine traffic received from hub-side port 24A and redundant hub-side port 24C, and output that combined traffic to the common port of the WSS 27.

Of course, those skilled in the art will appreciate that FIG. 7 can be extended to embodiments with a bypass path 30 as well. In such a case, the node 20 in FIG. 4 may have a redundant hub-side port 24C to provide redundancy for hub-side port 24A, as well as a redundant hub-side port 24D to provide redundancy for hub-side port 24B.

In still other embodiments, the node 20 employs both redundancy for a lower-tiered network or a peer network node 16, and redundancy for its connection to the hub node 18. Such embodiments may utilize an additional WSS for realizing this enhanced resiliency. Although this increases complexity and cost, the embodiments still achieve greater functionality than that of known approaches with comparable complexity and cost.

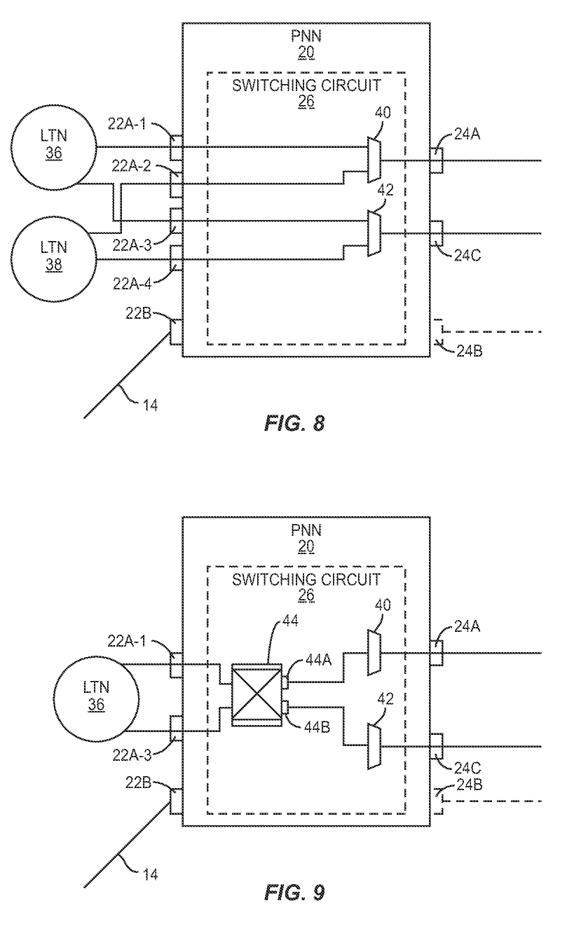

FIG. 8 illustrates one embodiment of a node 20 with enhanced resiliency. As shown, the node 20 includes four lower-tiered ports 22A-1, 22A-2, 22A-3, and 22A-4. Lower-tiered ports 22A-1 and 22A-3 are both connected to lower-tiered network 36 and therefore both receive the same traffic. Likewise, lower-tiered ports 22A-2 and 22A-4 are both connected to lower-tiered network 38 and therefore both receive the same traffic.

The switching circuit 26 includes a first WSS 40 and a second WSS 42. The first WSS 40 includes two dedicated ports that connect to or otherwise correspond to lower-tiered ports 22A-1 and 22A-2. The second WSS 42 includes two dedicated ports that connect to or otherwise correspond to lower-tiered ports 22A-3 and 22A-4. Configured in this way, the first WSS 40 is configured to direct traffic from lower-tiered network 36, as received at lower-tiered port 22A-1, to hub-side port 24A, while the second WSS 42 is configured to direct traffic from that lower-tiered network 36, as received at lower-tiered port 22A-3, to redundant hub-side port 24C. Similarly, the first WSS 40 is configured to direct traffic from lower-tiered network 38, as received at lower-tiered port 22A-2, to hub-side port 24A, while the second WSS 42 is configured to direct traffic from that lower-tiered network 38, as received at lower-tiered port 22A-4, to redundant hub-side port 24C.

While the example in FIG. 8 illustrates redundancy in the context of lower-tiered networks, those skilled in the art will appreciate that the embodiment may be extended to redundancy of the peer port 22B as well. In any event, such an arrangement not only provides the redundancy discussed above, but also provides redundancy to protect against WSS failure. Moreover, the multiple WSSs increase the number of possible lower-tiered connections to the node 20.

FIG. 9 illustrates a variation of the above embodiment that provides even greater resiliency. More particularly, the variation protects against a simultaneous failure in both a connection to a lower-tiered network and a connection to a hub node 18. For purposes of illustration, the variation is shown in FIG. 9 in the context of a simplified example that involves only a single lower-tiered network 36. Those skilled in the art will appreciate that the variation may be extended to multiple lower-tiered networks.

Nonetheless, as shown, the switching circuit 26 further comprises an optical switch 44. The optical switch 44 includes a first port 44A and a second port 44B. The switch 44 is configured to dynamically switch the traffic from lower-tiered network 36, as received at lower-tiered port 22A-1, to either the first or second port 44A, 44B of the optical switch 44. The switch 44 is further configured to dynamically switch the traffic from lower-tiered network 36, as received at lower-tiered port 22A-3, to either the first or second port 44A, 44B of the optical switch 44. Such dynamic switching is performed responsive to a control signal associated with any faults in the higher or lower-tiered networks affecting those ports 22A-1, 22A-3.

With the switch 44 configured in this way, the first WSS 40 is configured to direct the traffic received from the first port 44A of the optical switch 44 to hub-side port 24A. Meanwhile, the second WSS 42 is configured to direct the traffic received from the second port 44B of the optical switch 44 to redundant hub-side port 24C.

Such provides protection against a simultaneous failure in both a connection to lower-tiered network 36 and a connection to a hub node 18. Consider an example where both the connection to lower-tiered network 36 at port 22A-1 fails and the connection to redundant hub node 18C at port 24C fails. In this case, the optical switch 44 is configured to dynamically switch the traffic from lower-tiered network 36, as received at port 22A-3, to the first port 44A of the optical switch 44. The first WSS 40 correspondingly directs this traffic to the hub-side port 24A, for transport to hub node 18A.

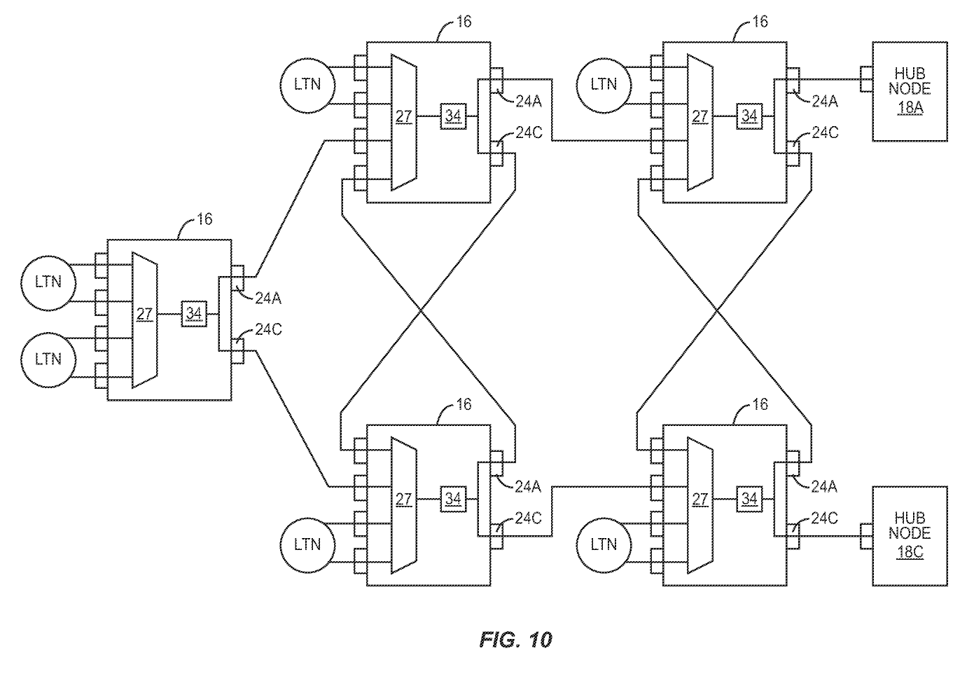

Those skilled in the art will of course appreciate that the redundant embodiments shown in FIGS. 6-9 have been simplified in many respects for purposes of illustration. For example, the particular way in which the node 20 connects to the hub nodes 18A, 18C in a redundant fashion may vary, and those connections may be made via any number of intermediate peer network nodes 16. FIG. 10 illustrates this latter variation, for instance, in the context of several peer network nodes 16 configured according to FIG. 7. As shown in FIG. 10, a given node 16 may connect one of its hub-side ports 24A, 24C to the peer port 22B of a different node 16 in order to realize a redundant connection to a different hub node 18.

Those skilled in the art will further appreciate that while embodiments herein reduce the routing flexibility of a peer network node 16, the embodiments actually provide more flexibility in terms of the wavelengths used to transport traffic. In this regard, the switching circuit 26 in one or more embodiments is configured to dynamically adapt the wavelengths used for transporting traffic to or from any given dedicated port 22, responsive to a control signal received from a hub node 18. This control signal may be sent, for instance, upon the introduction of additional traffic to the network, whereupon the switching circuit 26 dynamically allocates an additional wavelength for the traffic. Contrary to known ROADM architectures, dynamic allocation may entail re-assigning wavelengths across different dedicated ports 22, as needed.

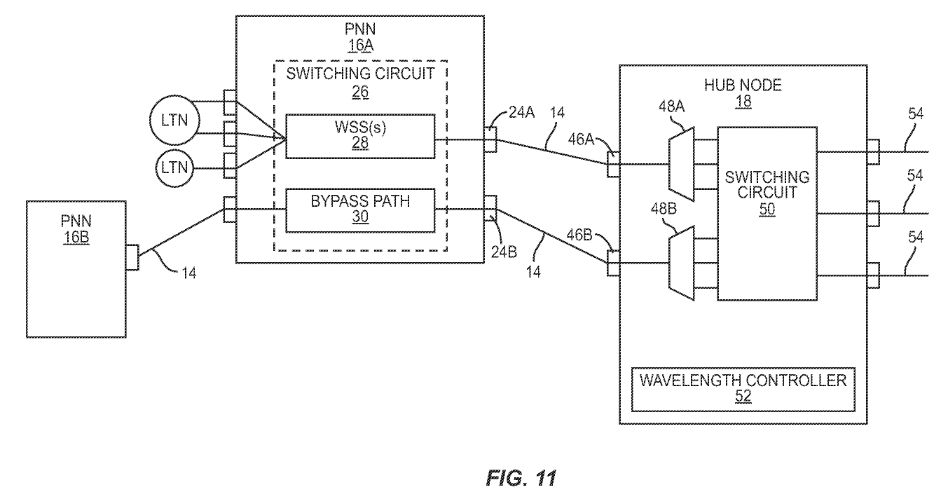

Turning now to additional details of a hub node 18, FIG. 11 illustrates one or more embodiments of a hub node 18 configured for use with peer network nodes 16 from FIG. 3 or 4. As shown, the hub node 18 includes bidirectional optical ports 46A, 46B that are each dedicated for transporting traffic to and from an individual peer network node 16A, 16B. The hub node 18 also includes a switching circuit 50 that comprises WSSs 48A, 48B. WSSs 48A and 48B are each dedicated for selectively switching traffic transported by an individual bidirectional port 46A, 48B to and from a plurality of edge nodes (via connections 54). This architecture advantageously reduces the complexity and cost of a hub node 18, as compared to known approaches, while providing simplistic yet sufficient routing flexibility for a wide range of applications.

FIG. 11 further illustrates that the hub node 18 may include a wavelength controller 52. In some embodiments, this wavelength controller 52 is configured to generate a control signal used for protection switching according to various embodiments discussed above. In one embodiment, for example, the wavelength controller 52 is configured to monitor reports obtained regarding any faults in the higher or lower-tiered networks that affect the route via which the hub node 18 receives traffic. Based on this monitoring, the wavelength controller 52 generates a control signal that dynamically controls a peer network node's selection between which of multiple different dedicated ports 22 the peer network node 16 acquires the same traffic for directing to the hub node 18. The wavelength controller 52 then sends the generated control signal to that peer network node 16. In another embodiment, the wavelength controller 52 additionally or alternatively is configured to generate a control signal, based on monitoring fault reports, that dynamically controls to which of multiple wavelength selective switches 40, 42 in a peer network node 16 an optical switch 44 in that peer network node 16 directs traffic received at a given dedicated port 22A-1, 22A-3.

In one or more other embodiments, the wavelength controller 52 is additionally or alternatively configured to generate and send a control signal that directs a peer network node 16 to dynamically adapt the wavelengths used for transporting traffic to or from any given dedicated port 22 of that peer network node 16. Such generation may be performed responsive to determining that new traffic is to be introduced or otherwise transported by the network.

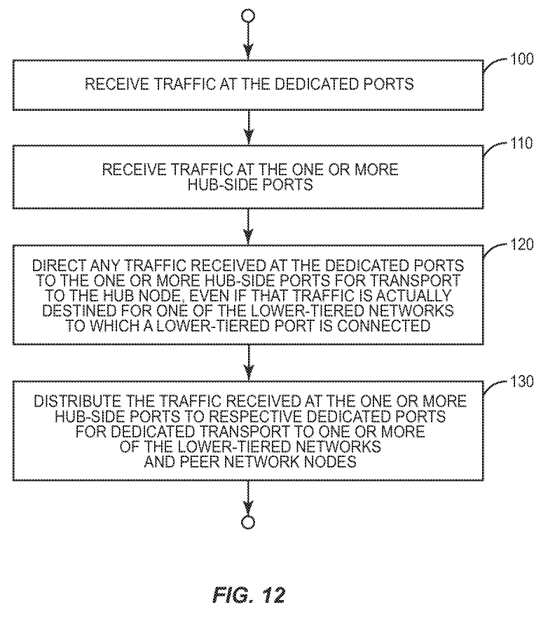

In view of the above modifications and variations, those skilled in the art will appreciate that a peer network node 16 herein generally performs the processing shown in FIG. 12. As shown in FIG. 12, processing includes receiving traffic at a plurality of dedicated bidirectional optical ports 22, including two or more lower-tiered ports 22A and one or more peer ports 22B (Block 100). Processing further includes receiving traffic at one or more hub-side bidirectional optical ports 24, with at least one of the hub-side ports 24 being a common port (Block 110). Processing then entails directing any traffic received at the dedicated ports 22 to the one or more hub-side ports 24 for transport to the hub node 18, even if that traffic is actually destined for one of the lower-tiered networks to which a lower-tiered port 22A is connected (Block 120). Finally, processing includes distributing the traffic received at the one or more hub-side ports 24 to respective dedicated ports 22 for dedicated transport to one or more of the lower-tiered networks and peer network nodes 16 (Block 130).

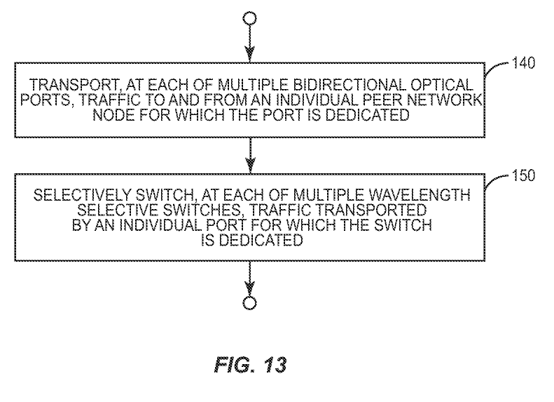

Likewise, those skilled in the art will appreciate that a hub node 18 herein generally performs the processing shown in FIG. 13. As shown in FIG. 13, such processing includes transporting, at each of multiple bidirectional optical ports 46, traffic to and from an individual peer network node 16 for which the port 46 is dedicated (Block 140). Processing then entails selectively switching, at each of multiple wavelength selective switches 48, traffic transported by an individual port 46 for which the switch 48 is dedicated to and from a plurality of edge nodes (Block 150).

Still further, those skilled in the art will understand that no particular type of WDM is required to practice the above embodiments. Thus, the embodiments may employ coarse WDM or dense WDM. The embodiments may even be used in the context of a WDM passive optical network (WDM-PON), with or without inverse return to zero/return to zero (IRZ/RZ) wavelength re-use. In one embodiment, for instance, the embodiments utilize 25 GHz channel spacing in both C and L bands, allowing for up to 400 wavelength channels per fiber. Another embodiment utilizes up to 100 GHz channel spacing.

Likewise, no particular type of technology is required to implement the one or more WSSs employed by the above embodiments. Indeed, WSSs herein may be realized using array waveguide gratings (AWGs), microelectromechnical systems (MEMs), liquid crystal on silicon (LCoS), or any other technology that may permit selective switching of optical signals on a per-wavelength basis.

Thus, those skilled in the art will recognize that the present invention may be carried out in other ways than those specifically set forth herein without departing from essential characteristics of the invention. The present embodiments are thus to be considered in all respects as illustrative and not restrictive, and all changes coming within the meaning and equivalency range of the appended claims are intended to be embraced therein.

What is claimed is:

1. A first one of multiple peer network nodes configured to form a higher-tiered optical network that transports wavelength division multiplexed (WDM) traffic for multiple lower-tiered optical networks, the first network node comprising:
a plurality of dedicated bidirectional optical ports, including two or more lower-tiered ports that are each dedicated for transporting traffic to and from an individual lower-tiered network via a single optical fiber and one or more peer ports that are each dedicated for transporting traffic to and from an individual peer network node via a single optical fiber;
one or more hub-side bidirectional optical ports that are each configured to transport traffic to and from a hub node in the higher-tiered network via a single optical fiber, wherein at least one of the hub-side ports is a common port configured to transport traffic aggregated across multiple lower-tiered ports; and
a switching circuit configured to direct any traffic received at the dedicated ports to the one or more hub-side ports for transport to the hub node, even if that traffic is actually destined for one of the lower-tiered networks to which a lower-tiered port is connected, and to distribute traffic received at the one or more hub-side ports to respective dedicated ports for dedicated transport to one or more of said lower-tiered networks and peer network nodes.

2. The first network node of claim 1, wherein the switching circuit comprises one or more wavelength selective switches and further comprises a bypass path configured to:
bypass traffic received at a first one of the peer ports around any wavelength selective switch to a first one of the hub-side ports, for transport to the hub node; and
bypass traffic received at said first hub-side port around any wavelength selective switch to said first peer port, for transport to the associated peer network node.

3. The first network node of claim 1, wherein the switching circuit comprises a wavelength selective switch, wherein the lower-tiered ports correspond to at least some of the dedicated ports of the wavelength selective switch, and wherein at least a first one of the hub-side ports corresponds to a common port of the wavelength selective switch.

4. The first network node of claim 3, wherein one or more of the peer ports corresponds to one or more dedicated ports of the wavelength selective switch.

5. The first network node of claim 1, wherein the switching circuit comprises a single wavelength selective switch.

6. The first network node of claim 1, wherein at least two different dedicated ports receive the same traffic, and wherein the switching circuit is configured to direct that traffic to a first one of the hub-side ports by dynamically selecting from which dedicated port to acquire the traffic, responsive to a control signal associated with any faults in the higher or lower-tiered networks affecting those ports.

7. The first network node of claim 6, wherein the switching circuit comprises a wavelength selective switch, and wherein said at least two different dedicated ports correspond to at least two different dedicated ports of the wavelength selective switch.

8. The first network node of claim 1, further comprising one or more redundant hub-side bidirectional optical ports that are each configured to transport traffic to and from a redundant hub node in the higher-tiered network, and wherein the switching circuit is configured to direct any traffic received at the dedicated ports also to the one or more redundant hub-side ports for transport to the redundant hub node.

9. The first network node of claim 8, wherein the switching circuit comprises a wavelength selective switch and a splitter/combiner circuit, wherein the lower-tiered ports correspond to at least some of the dedicated ports of the wavelength selective switch, wherein the wavelength selective switch is configured to aggregate traffic received at its dedicated ports and output that aggregated traffic at a common port of the wavelength selective switch, and wherein the splitter/combiner circuit is configured to distribute the traffic output from the common port of the wavelength selective switch to one or more of said hub-side ports and to one or more of said redundant hub-side ports.

10. The first network node of claim 8, wherein first and second ones of the dedicated ports receive the same traffic, and wherein the switching circuit comprises:
a first wavelength selective switch configured to direct that traffic, as received at the first dedicated port, to a first one of the hub-side ports; and
a second wavelength selective switch configured to direct that traffic, as received at the second dedicated port, to a first one of the redundant hub-side ports.

11. The first network node of claim 8, wherein first and second ones of the dedicated ports receive the same traffic, and wherein the switching circuit comprises:
an optical switch that includes first and second ports and that is configured to dynamically switch the traffic, as received at the first dedicated port of the first network node, to either the first or second port of the optical switch, and to switch the traffic, as received at the second dedicated port of the first network node, to either the first or second port of the optical switch, responsive to a control signal associated with any faults in the higher or lower-tiered networks affecting those ports;
a first wavelength selective switch configured to direct the traffic received from the first port of the optical switch to a first one of said hub-side ports; and
a second wavelength selective switch configured to direct the traffic received from the second port of the optical switch to a first one of said redundant hub-side ports.

12. A method implemented by a first one of multiple peer network nodes configured to form a higher-tiered optical network that transports wavelength division multiplexed (WDM) traffic for multiple lower-tiered optical networks, the method comprising:
receiving traffic at a plurality of dedicated bidirectional optical ports, including two or more lower-tiered ports that are each dedicated for transporting traffic to and from an individual lower-tiered network via a single optical fiber and one or more peer ports that are each dedicated for transporting traffic to and from an individual peer network node via a single optical fiber;
receiving traffic at one or more hub-side bidirectional optical ports that are each configured to transport traffic to and from a hub node in the higher-tiered network via a single optical fiber, wherein at least one of the hub-side ports is a common port configured to transport traffic aggregated across multiple lower-tiered ports;
directing any traffic received at the dedicated ports to the one or more hub-side ports for transport to the hub node, even if that traffic is actually destined for one of the lower-tiered networks to which a lower-tiered port is connected; and
distributing the traffic received at the one or more hub-side ports to respective dedicated ports for dedicated transport to one or more of said lower-tiered networks and peer network nodes.

13. The method of claim 12, wherein said directing comprises:
bypassing traffic received at a first one of the peer ports around any wavelength selective switch in the first network node to a first one of the hub-side ports, for transport to the hub node; and
bypassing traffic received at said first hub-side port around any wavelength selective switch in the first network node to said first peer port, for transport to the associated peer network node.

14. The method of claim 12, wherein said directing comprises inputting traffic received at different ones of said lower-tiered ports into different dedicated ports of a wavelength selective switch configured to aggregate that traffic and to output the aggregated traffic at a common port that corresponds to at least one of the hub-side ports.

15. The method of claim 14, wherein said directing further comprises inputting traffic received at one or more of the peer ports into one or more dedicated ports of the wavelength selective switch.

16. The method of claim 12, wherein said directing and distributing are performed by a single wavelength selective switch comprised in the first network node.

17. The method of claim 12, wherein said receiving comprises receiving the same traffic at two or more different dedicated ports, and wherein said directing comprises directing that traffic to a first one of the hub-side ports by dynamically selecting from which dedicated port to acquire the traffic, responsive to a control signal associated with any faults in the higher or lower-tiered networks affecting those ports.

18. The method of claim 17, wherein said directing comprises inputting the traffic received at said two or more dedicated ports into two or more dedicated ports of a wavelength selective switch, and selecting from which dedicated port of the wavelength selective switch to acquire the traffic.

19. The method of claim 12, further comprising:
receiving traffic at one or more redundant hub-side bidirectional optical ports of the first network node that are each configured to transport traffic to and from a redundant hub node in the higher-tiered network; and
directing any traffic received at the dedicated ports also to the one or more redundant hub-side ports for transport to the redundant hub node.

20. The method of claim 19, wherein said directing comprises:
inputting traffic received at different ones of said lower-tiered ports into different dedicated ports of a wavelength selective switch;
aggregating the traffic received at the dedicated ports of the wavelength selective switch and outputting that aggregated traffic at a common port of the wavelength selective switch; and
distributing the aggregated traffic output from the common port of the wavelength selective switch to one or more of said hub-side ports and to one or more of said redundant hub-side ports.

21. The method of claim 19, wherein said receiving comprises receiving the same traffic at first and second ones of the dedicated ports, and wherein said directing comprises:
inputting that traffic, as received at the first dedicated port, into different dedicated ports of a first wavelength selective switch that is configured to direct the traffic to a first one of the hub-side ports; and
inputting that traffic, as received at the second dedicated port, into different dedicated ports of a second wavelength selective switch that is configured to direct the traffic to a first one of the redundant hub-side ports.

22. The method of claim 19, wherein said receiving comprises receiving the same traffic at first and second ones of the dedicated ports, and wherein said directing comprises:
dynamically switching the traffic, as received at the first dedicated port of the first network node, to either a first or second port of an optical switch, and dynamically switching the traffic, as received at the second dedicated port of the first network node, to either the first or second port of the optical switch, responsive to a control signal associated with any faults in the higher or lower-tiered networks affecting those ports;
inputting that traffic, as received from the first port of the optical switch, into different dedicated ports of a first wavelength selective switch that is configured to direct the traffic to a first one of the hub-side ports; and
inputting that traffic, as received from the second port of the optical switch, into different dedicated ports of a second wavelength selective switch that is configured to direct the traffic to a first one of the redundant hub-side ports.

23. A hub node in a higher-tiered optical network formed from multiple peer network nodes that transport wavelength division multiplexed (WDM) traffic for multiple lower-tiered optical networks, the hub node comprising:
bidirectional optical ports that are each dedicated for transporting traffic to and from an individual peer network node; and
a switching circuit that comprises wavelength selective switches that are each dedicated for selectively switching traffic transported by an individual bidirectional port to and from a plurality of edge nodes.

24. The hub node of claim 23, further comprising a protection controller configured to:
monitor reports obtained regarding any faults in the higher or lower-tiered networks that affect the route via which the hub node receives traffic;
generate a control signal, based on said monitoring, that dynamically controls a peer network node's selection between which of multiple different dedicated ports the peer network node acquires the same traffic for directing to the hub node; and
send the generated control signal to that peer network node.

25. The hub node of claim 23, further comprising a protection controller configured to:
monitor reports obtained regarding any faults in the higher or lower-tiered networks that affect the route via which the hub node receives traffic;
generate a control signal, based on said monitoring, that dynamically controls to which of multiple wavelength selective switches in a peer network node an optical switch in that peer network node directs traffic received at a given dedicated port; and
send the generated control signal to that peer network node.

26. A method implemented by a hub node in a higher-tiered optical network formed from multiple peer network nodes that transport wavelength division multiplexed (WDM) traffic for multiple lower-tiered optical networks, the method comprising:
transporting, at each of multiple bidirectional optical ports, traffic to and from an individual peer network node for which the port is dedicated; and
selectively switching, at each of multiple wavelength selective switches, traffic transported by an individual port for which the switch is dedicated to and from a plurality of edge nodes.

27. The method of claim 26, further comprising:
monitoring reports obtained regarding any faults in the higher or lower-tiered networks that affect the route via which the hub node receives traffic;
generating a control signal, based on said monitoring, that dynamically controls a peer network node's selection between which of multiple different dedicated ports the peer network node acquires the same traffic for directing to the hub node; and
sending the generated control signal to that peer network node.

28. The method of claim 26, further comprising:
monitoring reports obtained regarding any faults in the higher or lower-tiered networks that affect the route via which the hub node receives traffic;
generating a control signal, based on said monitoring, that dynamically controls to which of multiple wavelength selective switches in a peer network node an optical switch in that peer network node directs traffic received at a given dedicated port; and
sending the generated control signal to that peer network node.
